(19) United States
(12) Patent Application Publication
(10) Pub. No.: US 2018/0253904 A1
(43) Pub. Date: Sep. 6, 2018

(54) VEHICLE HEAD-UP DISPLAY DEVICE

(71) Applicant: Calsonic Kansei Corporation, Saitama-shi (JP)

(72) Inventor: Kouji KUWABARA, Saitama-shi (JP)

(21) Appl. No.: 15/902,000

(22) Filed: Feb. 22, 2018

(30) Foreign Application Priority Data
Mar. 2, 2017 (JP) 2017-039590

(51) Int. Cl. G06T 19/00; G06K 9/00; B60K 37/02; B60R 1/00; G08G 1/16; G02B 27/01

(52) U.S. Cl. CPC G06T 19/006; G02B 2027/014; G06K 9/00671; B60K 37/02; B60R 1/001; G08G 1/167; G02B 27/0101; B60K 2350/1072; B60K 2350/2052; B60K 2350/2065; B60K 2350/2013; B60K 2350/1096; B60R 2300/205; B60R 2300/302; B60R 2300/306; B60R 2300/804; G02B 2027/0141; G02B 2027/0138; G06K 9/00791

(57) ABSTRACT

A vehicle head-up display device includes a display device and a display control device. The display device is configured to perform reflective display of driving support information on a windshield of a vehicle. The display control device is configured to control the display device, and including a synthesized image generating unit configured to synthesize required display information and a live-action image taken by a camera to display a synthesized image of the required display information and the live-action image on an entirety or a part of a screen of the display device.

### CROSS-REFERENCE TO RELATED APPLICATIONS

This application claims priority to Japanese Patent Application No. 2017-039590, filed on Mar. 2, 2017. The entire disclosure of Japanese Patent Application No. 2017-039590 is hereby incorporated herein by reference.

### BACKGROUND

### Field of the Invention

The present invention relates to a vehicle head-up display device.

### Background Information

There have been vehicles such as automobiles, etc., in which a head-up display device (a vehicle head-up display device) is installed (see Japanese Laid-Open Patent Application Publication No. 2005-313772, for example). This head-up display device is equipped with a display device capable of reflectively displaying driving support information on the windshield.

### SUMMARY

With the head-up display for a vehicle disclosed in the abovementioned publication, the display position is controlled so that the display of the vehicle head-up display device overlaps the scenery that can be seen through the windshield (particularly the object the driver is gazing at, etc.) according to the physical constitution and movement of the driver, etc. Because this requires a camera for capturing the driver, for example, the device structure becomes complicated and large in scale.

Accordingly, one of the objects of the present invention is to address the problem noted above.

A vehicle head-up display device according to one aspect includes a display device and a display control device. The display device is configured to perform reflective display of driving support information on a windshield of a vehicle. The display control device is configured to control the display device, and including a synthesized image generating unit configured to synthesize required display information and a live-action image taken by a camera to display a synthesized image of the required display information and the live-action image on an entirety or a part of a screen of the display device.

With the above aspect, it is possible to perform intuitively easy to understand display using a simple device structure.

### BRIEF DESCRIPTION OF THE DRAWINGS

Referring now to the attached drawings which form a part of this original disclosure:

FIG. 1 is a schematic diagram of a vehicle head-up display device according to one embodiment.

FIG. 2 is a block diagram of a display control device show in FIG. 1 according to the embodiment.

FIG. 3A is a drawing showing a display example (status display) during preceding vehicle detection by the vehicle head-up display device shown in FIG. 1 according to the embodiment.

FIG. 3B is a drawing showing a display example (warning display) during lane cutting vehicle detection similar to FIG. 3A.

FIG. 4A is a drawing showing a display example (status display) during lane detection by the vehicle head-up display device shown in FIG. 1 according to the embodiment.

FIG. 4B is a drawing showing a display example (warning display) during lane departure similar to FIG. 4A.

FIG. 5 is a drawing showing the display position of a synthesized image in the vehicle head-up display device according to the embodiment.

FIG. 6 is a drawing showing another example of the display position of a synthesized image in the vehicle head-up display device according to the embodiment.

FIG. 7A is a drawing showing the trimming status of a live-action image when trimmed at an aspect ratio of 1:1 according to the embodiment.

FIG. 7B is a drawing showing the trimming status of a live-action image when trimmed at an aspect ratio of 3:5 according to the embodiment.

FIG. 8A is a drawing showing the size of the synthesized image having an aspect ratio of 1:1 according to the embodiment.

FIG. 8B is a drawing showing the size of the synthesized image having an aspect ratio of 3:5 according to the embodiment.

FIG. 9 is a basic flow chart of the display control performed by the display control device according to the embodiment.

FIG. 10 is a flow chart of the display control in a case where the size and display position are changeable according to the embodiment.

### DETAILED DESCRIPTION OF EMBODIMENTS

Selected embodiments will now be explained with reference to the drawings. It will be apparent to those skilled in the art from this disclosure that the following descriptions of the embodiments are provided for illustration only and not for the purpose of limiting the invention as defined by the appended claims and their equivalents.

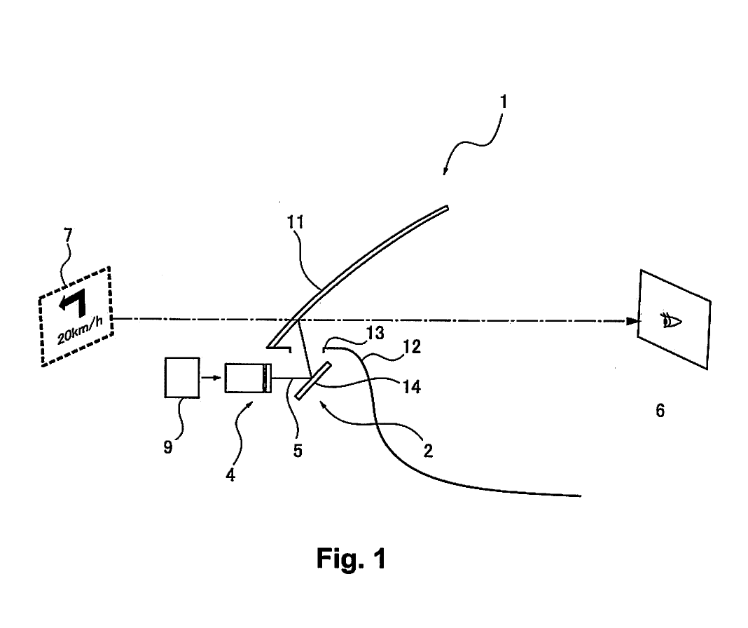

Following is a detailed explanation of an embodiment using the drawings. FIG. 1 through FIG. 10 are for explaining this embodiment.

### Structure

Following, the structure of this embodiment is explained.

As shown in FIG. 1, a head-up display device 2 (vehicle head-up display device) is installed in a vehicle 1 such as an automobile, etc. This head-up display device 2 is equipped with a display device 4 capable of performing reflective display of driving support information on a windshield 11.

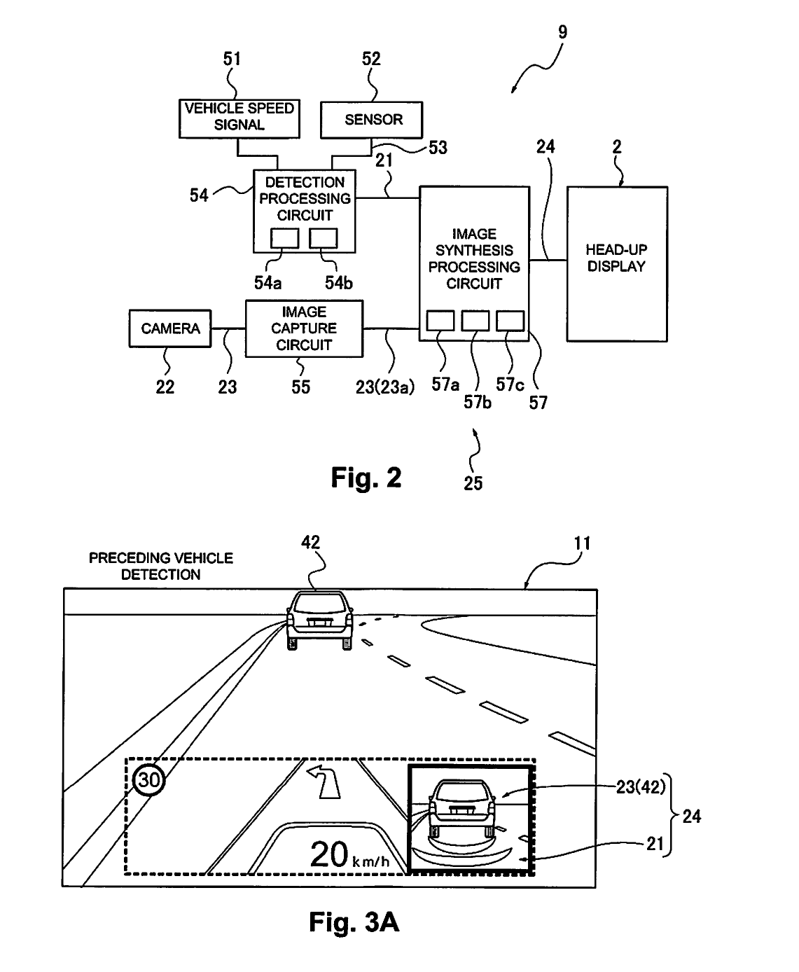

Also, the head-up display device 2 has a display control device 9 (see FIG. 2) for controlling the display of the display device 4. The display control device 9 includes a computer that executes a predetermined control program and a memory that stores information used for various control programs and various control processes. The computer includes, for example, a central processing unit (CPU) or a micro-processing unit (MPU).

Here, the driving support information may be, for example, a typical information such as speed information, route information, etc. (normal display). The display device 4 may be a display panel such as liquid crystal or organic EL, etc., or a screen for displaying a video image of a projector, etc.

With this embodiment, the head-up display device 2 is attached to a portion of an instrument panel 12 provided in the vehicle 1. Specifically, an image 5 of the display device 4 installed inside the instrument panel 12 is reflected on the windshield 11 through an opening part 13 provided on the instrument panel 12. The windshield 11 is configured to reflect the display of the display device 4 by using, for example, glass with a wedge shaped cross section, etc. With this head-up display device 2, a virtual image 7 is displayed in front of the windshield 11. This virtual image 7 is displayed overlapping the outside scenery, or alongside the outside scenery, seen through the windshield 11 by a vehicle occupant sitting in a driver seat 6.

At a position between the display device 4 and the windshield 11 on the interior of the instrument panel 12, it is possible to install one or a plurality of optical components 14 such as a reflecting mirror that guides the displayed image of the display device 4 to the windshield 11, or a magnifying lens that guides the displayed image of the display device 4 while magnifying the image to the windshield 11, etc. However, the specific structure of the head-up display device 2 is not limited to the configurations noted above.

With this embodiment, the structures noted below are provided on the basic structure described above.

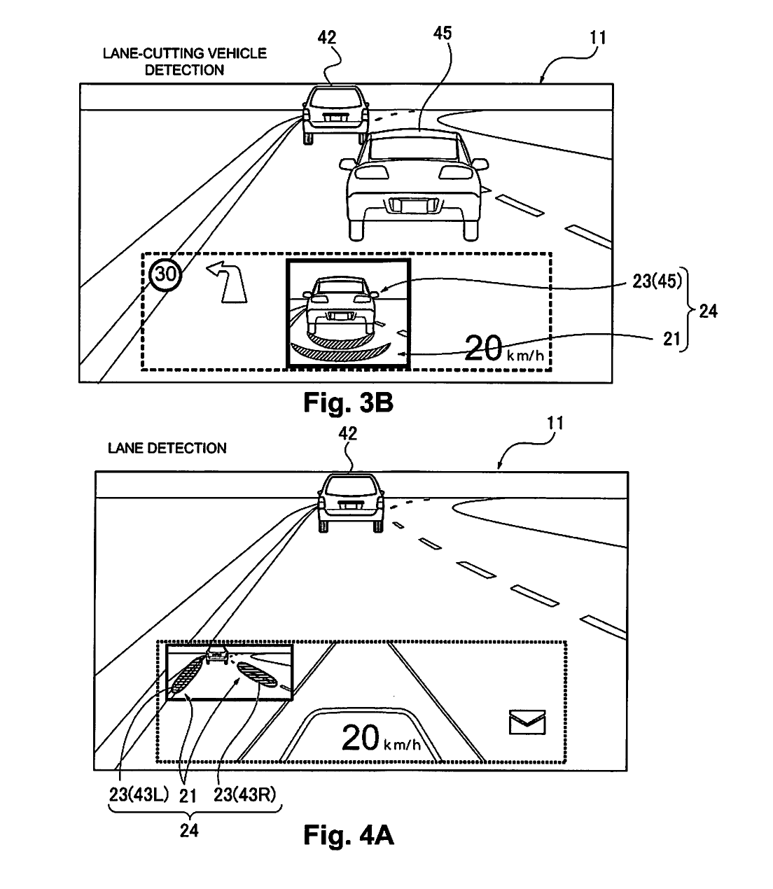

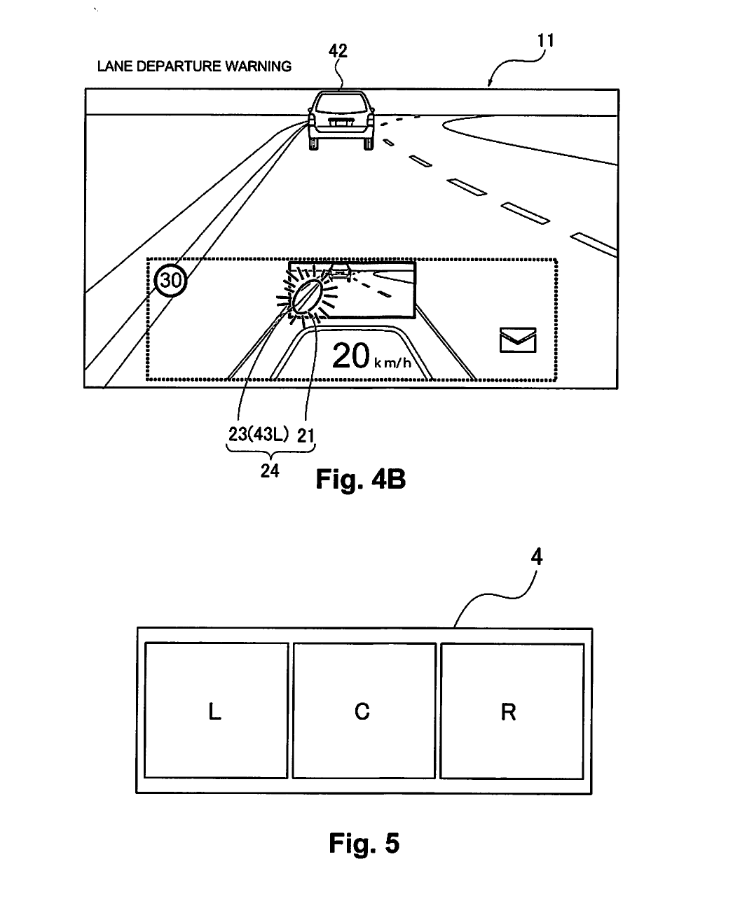

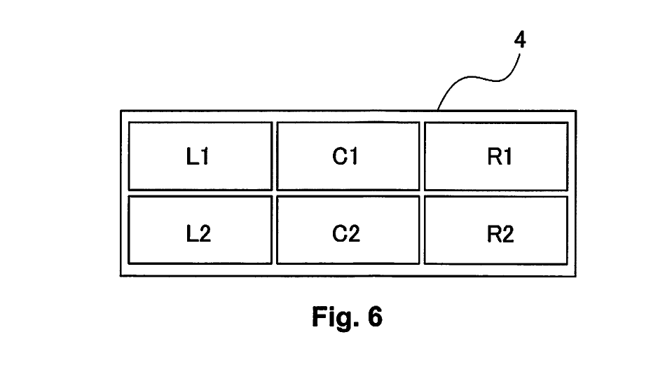

(1) As shown in FIG. 2, the display control device 9 is provided with a synthesized image generating unit 25 that synthesizes information that needs to be displayed (hereinafter called “required display information 21”) and a live-action image 23 taken using a camera 22, and is configured (i.e., programmed) to display a synthesized image 24 (see the item shown as the display example on the windshield 11 in FIG. 3A to FIG. 4B, etc.) on an entirety or a part of the screen of the display device 4 (see FIG. 5 and FIG. 6).

Here, the required display information 21 may be information that relates to normal display such as the abovementioned speed information, route information, etc., or it may be special information other than the normal display. The required display information 21 may be, for example, information for which special display is needed, such as a phenomenon or event that occurs suddenly or accidentally while traveling, or a phenomenon or event, etc. that occurs non-periodically or non-regularly, etc., or alternatively, is special information for which the need for display arises at a special location while traveling, etc.

Among various cameras attached to the vehicle 1, the camera 22 that captures the live-action image of mainly in front of the vehicle 1 is used as the camera 22 that captures the live-action image 23. However, it is also possible to use a camera or cameras other than the forward capturing camera 22.

The synthesized image 24 is an image for which the required display information 21 is put into graphic or symbol form for easily understanding the meaning, and overlapped on an entirety or a part of the live-action image 23.

(2) The synthesized image generating unit 25 may also be configured so as to acquire the live-action image 23 from the camera 22 when it is determined that there is required display information 21 while travelling, to generate the synthesized image 24, and to perform interrupt display on the screen of the display device 4.

Here, in a case such as when a different device with the abovementioned camera 22 mounted on the vehicle 1 (e.g. an automatic braking system, a lane detection system, an automatic driving system etc.) is being used for a different purpose, the synthesized image generating unit 25 may be configured to take in the live-action image 23 from the abovementioned other device by the amount needed for processing. The screen of the display device 4 before interrupt is, for example, a normal display that displays driving support information such as speed information, route information, etc. The interrupt display may include the synthesized image 24 displayed instead of the normal display, or displayed overlapping the normal display. While interrupt display is being performed, a display position of the normal display may be moved to a position in an areas that is open other than the synthesized image 24. The interrupt display of the synthesized image 24 may be performed temporarily (specifically, only for the time necessary for the driver to recognize it). The necessary time is assumed to be a relatively short time of, for example, from approximately a few seconds to an approximately a dozen seconds or more. After the interrupt display, the normal display returns.

(3) The synthesized image generating unit 25 may change the display position of the synthesized image 24 according to the importance level of the required display information 21.

Here, the importance level of the required display information 21 can be divided into at least two levels of: a status display that displays the vehicle status of the vehicle 1, the traveling status, the driver status, etc. (see FIG. 3A and FIG. 4A for example), and a warning display that performs a warning to avoid danger, etc. (see FIG. 3B and FIG. 4B, for example) (importance level: status display<warning display). However, the importance level of the information can also be divided into three or more levels.

The display position of the synthesized image 24 can, as shown in FIG. 5 for example, be any of three locations of: the center region C, the right side region R, or the left side region L of the surface of the display device 4. Also, as shown in FIG. 6 for example, it is possible to use any of six regions for which the three regions of the center region C, the right side region R, and the left side region L are divided at top and bottom (upper center region C1, lower center region C2, upper right side region R1, lower right side region R2, upper left side region L1, and lower left side region L2).

Also, for example, regarding high importance level information, it is possible to display the information with a position that easily catches driver's eye regardless of where in the driver's line of sight it is (e.g. center region C, upper center region C1, lower center region C2, etc.) as the preset position, and for low importance level information, to display the information in a position related to that information (e.g. center region C, right side region R, left side region L, or any of the six regions noted above), or other open position, etc.

Depending on the structure of the optical path from the display device 4 to the windshield 11, the image 5 of the display device 4 may be inverted vertically and projected on the windshield 11. The display positions are illustrated in FIG. 5 and FIG. 6 to show the state of being pictured on the windshield 11.

(4) The synthesized image generating unit 25 may change the size of the synthesized image 24 according to an object 41 of the required display information 21.

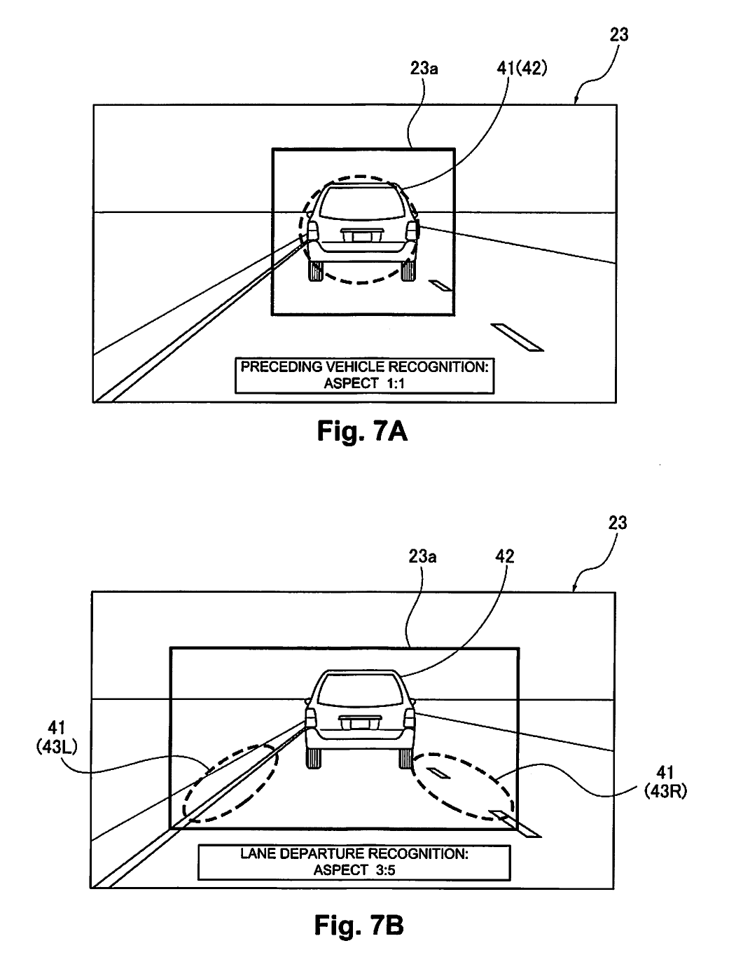

Here, as shown in FIGS. 7A and 7B, the live-action image 23 captured by the camera 22 is preferably used after trimming the image to extract the necessary part (trimmed image 23a). The trimming is performed automatically to match the size, shape, etc. of the object 41.

The object 41 is an item that is subject to performance of status display or warning display, and for example, the object 41 is automatically changed to the preceding vehicle (e.g. vehicle 42), the lane boundary line 43R, 43L, a pedestrian, or an obstacle in the lane, etc., according to the contents of the required display information 21.

The size of the synthesized image 24 is the size (size and aspect ratio) of the portion used after trimming from the live-action image 23 of the camera 22. Even when from the same live-action image 23, there will be a different size of the synthesized image 24 according to the object 41 that is displayed.

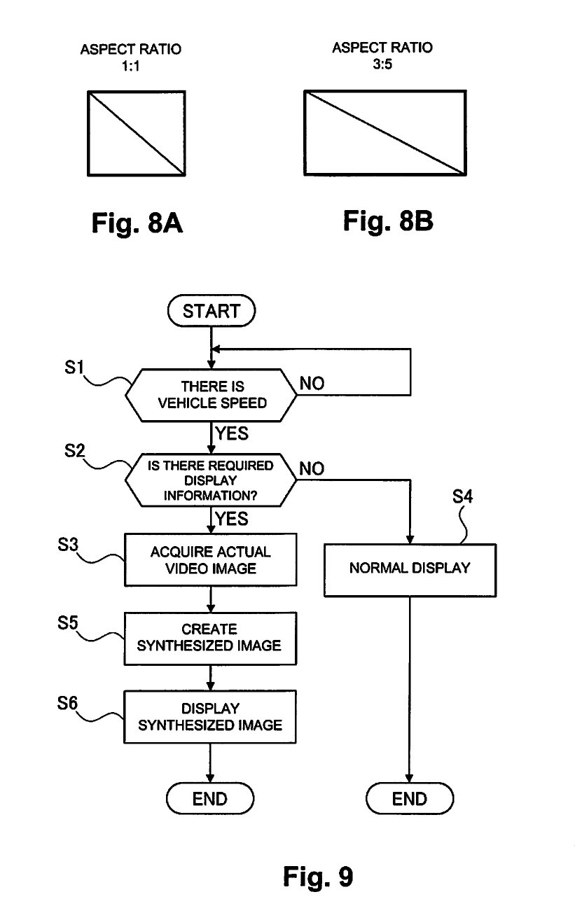

For example, when the object 41 is a preceding vehicle (e.g. vehicle 42), when trimming the live-action image 23 to extract the preceding vehicle (e.g. vehicle 42), or to extract a portion in a range slightly larger than the preceding vehicle (e.g. vehicle 42), the trimmed image becomes a square shape size of aspect ratio 1:1 such as that shown in FIG. 8A.

Also, when the object 41 is a lane, when trimming the live-action image 23 to extract a portion of the desired range including boundary lines 43R, 43L of both sides of the traveling lane, the trimmed image becomes a horizontally elongated size of aspect ratio 3:5 as shown in FIG. 8B.

An image trimmed to a 1:1 aspect ratio (trimmed image 23a) is preferably displayed in any of the three regions of the center region C, the right side region R, and the left side region L.

Also, an image trimmed to a 3:5 aspect ratio (trimmed image 23a) is preferably displayed at any of the six regions noted above (upper center region C1, lower center region C2, upper right side region R1, lower right side region R2, upper left side region L1, and lower left side region L2).

With the description above, the synthesized image 24 is made so that two sizes can be selected, the sizes with a 1:1 aspect ratio and with a 3:5 aspect ratio. However, the invention is not limited to this configuration, and it is also possible to be able to select the size from a larger number of sizes.

(5) Also, as shown in FIG. 2, the synthesized image generating unit 25 may also be equipped with a detection processing circuit unit 54 configured to process a vehicle speed signal 51 and detection signal(s) 53 from sensor(s) 52, an image capture circuit unit 55 configured to acquire the live-action image 23 from the camera 22, and an image synthesis processing circuit unit 57 configured to synthesize signals from the detection processing circuit unit 54 and the image capture circuit unit 55.

Here, the detection processing circuit unit 54 inputs the vehicle speed signal 51, other vehicle control signals, or information from various sensor(s) 52 attached to the vehicle 1, etc., and by performing the necessary information processing, determines whether it is information that needs to be displayed (or whether “there is required display information 21”). Determination of whether there is required display information 21 may be performed using conventional image processing technology or control technology, or may be performed using artificial intelligence.

For the sensor(s) 52, it is possible to use various items installed on the vehicle 1. For the sensor(s) 52, it is possible to use items used for other devices such as the automatic braking system, the lane detection system, the automatic driving system, etc. (e.g. millimeter wave radar, infrared laser radar, or camera 22 (stereo camera or single camera)), etc. Also, the various cameras attached to the vehicle 1 may be collectively used as the sensor 52.

Also, the detection processing circuit unit 54 may also have an importance level judgment unit 54a configured to judge the importance level of the information. The judgment of the importance level of the information may be performed in advance using a determination table 54b, etc. that picks up phenomena that can become required display information 21 and classifies it into status display or warning display.

The importance level judgment unit 54a may perform a determination of a change in the importance level from status display to warning display (importance level up), or a change in the importance level from warning display to status display (importance level down) based on a preset threshold value or a count value of a determination count, etc. It is also possible to change the display position to match the change in importance level. Among the phenomena that can become the required display information 21, as high importance level items, for example, there are collision avoidance warnings, accelerator pressing error warnings, doze warnings, looking away warnings, and poor physical condition detection and warning, etc. At least a part of the functions of the detection processing circuit unit 54 may also be carried out using another device noted above.

The image capture circuit unit 55 may be a part that always captures the live-action image 23 from the camera 22, or it may also be a part that captures only the necessary length of time when needed.

The image synthesis processing circuit unit 57 may also have a trimming unit 57a configured to trim the live-action image 23 from the camera 22 to the necessary size including the necessary portion, a synthesis execution unit 57b configured to synthesize graphic or symbol showing the required display information 21 in the live-action image 23 trimmed using the trimming unit 57a, and to create the synthesized image 24, and an interrupt processing unit 57c configured to decide the display position of the synthesized image 24 and to perform interrupt display.

(6) In more specific terms, the head-up display device 2 may be configured to display at least, as shown in FIG. 3A and FIG. 3B, the synthesized image 24 that uses the preceding vehicle detection information for the required display information 21, and uses the preceding vehicle (vehicle 42 or (lane cutting) vehicle 45) for the live-action image 23, or as shown in FIG. 4A and FIG. 4B, uses the lane detection information for the required display information 21, and uses the lane (its boundary line 43R or 43L) for the live-action image 23.

### Operation

The operation of this embodiment is explained.

First, the flow of the basic process of the display control is explained using FIG. 9.

When the control starts, in step S1, the detection processing unit 54 determines whether “there is vehicle speed” (i.e., whether currently traveling or not) using the vehicle speed signal 51. When Yes (there is vehicle speed=currently traveling), the process advances to step S2, and when No (there is no vehicle speed=vehicle stopped), the step S1 loops and is in standby until the status changes to currently traveling.

In step S2, the detection processing circuit unit 54 determines whether “there is required display information 21” using the detection signal(s) 53 from the sensor(s) 52. When Yes (there is required display information 21), the process advances to step S3, and when No (there is no required display information 21), the process advances to step S4 and normal display (normal display) is performed, and this process cycle ends.

In step S3, the image capture circuit unit 55 acquires the live-action image 23 from the camera 22. Thereafter, the process advances to step S5.

In step S5, the image synthesis processing circuit unit 57 creates the synthesized image 24 by synthesizing the required display information 21 and the live-action image 23 captured by the camera 22. Thereafter, the process advances to step S6.

In step S6, the image synthesis processing circuit unit 57 interrupts the normal display, and displays the synthesized image 24 on the display device 4. Then, this process cycle ends. Thereafter, the abovementioned process show in FIG. 9 is repeated.

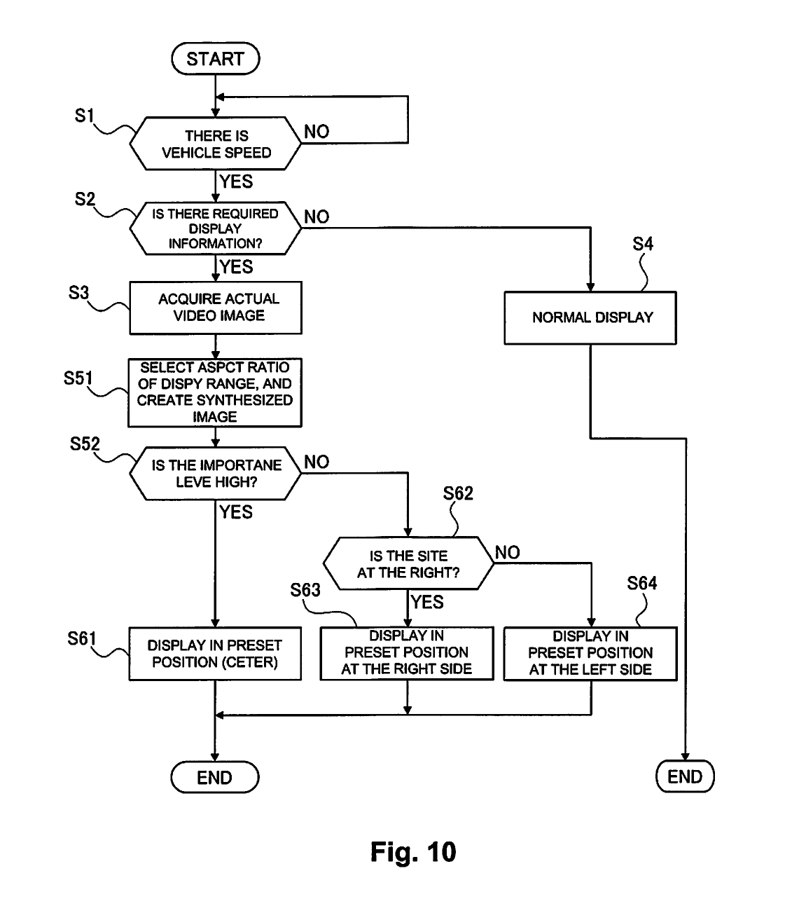

Next, the flow of the process of the display control when changing the size or display position of the synthesized image 24 is explained using FIG. 10.

In this case, up to step S4 is the same as FIG. 9 so the explanation is omitted. Then, in step S3, the image capture circuit unit 55 acquires the live-action image 23 from the camera 22, after which the process advances to step S51.

In step S51, the image synthesis processing circuit unit 57 selects the size (aspect ratio) of the portion (display region) that needs to be displayed with the live-action image 23 from the camera 22, trims the live-action image 23 to the selected size to synthesize the required display information 21, and creates the synthesized image 24. Thereafter, the process advances to step S52.

In step S52, the image synthesis processing circuit unit 57 judges the importance level of the required display information 21.

When Yes (i.e., when the importance level of the required display information 21 is high), the process advances to step S61, interrupt display of the synthesized image 24 is performed in a preset position (center region C), and one process ends.

When No (i.e., when the importance level of the required display information 21 is low), the process advances to step S62, and a determination is made for the relative position of the required display information 21 with respect to the live-action image 23 (e.g. is the site on the right? etc.).

When Yes (i.e., when the site is on the right), the process advances to step S63, the synthesized image 24 is interrupt displayed in a preset position on the right side (right side region R, right side region R1 or right side region R2), and one process cycle ends.

When No (i.e., when the site is on the left), the process advances to step S63, the synthesized image 24 is interrupt displayed at a preset position on the left side (left side region L, left side region L1, or left side region L2), and one process cycle ends. Thereafter, the abovementioned process in FIG. 10 is repeated.

### Effects

With this embodiment, it is possible to obtain the following effects.

### Effect 1

The required display information 21 and the live-action image 23 captured by the camera 22 are synthesized, and the synthesized image 24 is made to be displayed on an entirety or a part of the screen of the display device 4. As a result, it is possible to perform display that is intuitively easy to understand. Also, by having a configuration such that the synthesized image 24 is displayed as is on an entirety or a part of the screen of the display device 4, the display is at a set position in front. Because of that, for example, it is no longer necessary to control the display position so as to have the scenery from the windshield 11 and the display of the head-up device 2 overlap to match the physical constitution or movement of the vehicle occupant, etc. Therefore, it is possible to eliminate problems such as having the scenery and display be skewed, etc. In fact, since it is possible to perform intuitively easy to understand display as described above without making the display device unnecessarily complicated, it is possible to realize this effect simply and inexpensively using an already existing device structure.

### Effect 2

The synthesized image generating unit 25 acquires the live-action image 23 (the necessary portion thereof) from the camera 22 when it is determined that there is required display information 21 while traveling, generates the synthesized image 24, and performs interrupt display of the synthesized image 24 on the screen of the display device 4. As a result, it is possible to generate and display the necessary display when needed according to the status during driving. Thus, it is possible to for the vehicle occupant to efficiently obtain necessary information without feeling inconvenience, and also possible for the synthesized image generating unit 25 to reduce the processing burden.

### Effect 3

It can also be made possible for the synthesized image generating unit 25 to change the display position of the synthesized image 24 according to the importance level of the required display information 21. As a result, it is possible to perform the optimal attention alert according to the importance level of the required display information 21. Thus, it is possible to improve the visibility and ease of understanding of the display.

For example, in the case of FIG. 3A, since this is a status display for the preceding vehicle detection, it is possible to display this image in the right side region R (or center region C, or left side region L), etc., in FIG. 5. In the case of FIG. 3B, since this is a warning display for vehicle detection of a lane cutting vehicle, it is possible to display this in the center region C in FIG. 5. In the case of FIG. 4A, since this is a status display for lane detection, it is possible to display this in the upper left side region L1, etc., in FIG. 6. In the case of FIG. 4B, since this is a warning display for a lane departure, it is possible to display this in the upper center region C1 in FIG. 6.

### Effect 4

It can also be made possible for the synthesized image generating unit 25 to change the size of the synthesized image 24 according to the object 41 of the required display information 21. As a result, it is possible to perform the optimal display according to the object 41 of the required display information 21. Thus, it is possible to improve the visibility and ease of understanding of the display.

For example, it is possible to use an aspect ratio of 1:1 as shown in FIG. 3A and FIG. 3B or it is possible to use an aspect ratio of 3:5 as shown in FIG. 4A and FIG. 4B.

### Effect 5

The synthesized image generating unit 25 is equipped with the detection processing circuit unit 54 for processing vehicle speed signals 51 and detection signal(s) 53 from the sensor(s) 52, the image capture circuit unit 55 for acquiring the live-action image 23 from the camera 22, and the image synthesis processing circuit unit 57 for synthesizing signals from the detection processing circuit unit 54 and the image capture circuit unit 57. By using the configuration noted above, it is possible to obtain a feasible specific device structure.

### Effect 6

As shown in FIG. 3A, it is possible to perform display of the synthesized image 24 using the preceding vehicle detection information for the required display information 21, and using the preceding vehicle (vehicle 42) for the live-action image 23. As a result, it is possible to notify the vehicle occupant of which vehicle 42 is currently detected as the preceding vehicle by the host vehicle 1 (status display).

For example, in the automatic driving mode, when traveling while detecting the vehicle 42 traveling in front in the lane as the preceding vehicle, in cases such as when another vehicle 45 (see FIG. 3B) enters the host vehicle lane from an adjacent lane, if it is not known whether the preceding vehicle that the host vehicle is currently detecting is still the same prior vehicle 42, or if in fact it has moved to the vehicle 45 that entered the lane from the side, the driver will feel anxiety in regards to automatic driving. In such a case, if it is clearly understood that the detection object vehicle (preceding vehicle) has switched from the prior vehicle 42 to the vehicle 45 that just entered, it is possible for the driver to continue automatic driving with a sense of security.

Thus, in an occasion such as when the detection object vehicle is switched, if status display is performed appropriately, the display will be easy to understand and effective. In this case, it is possible to clearly notify the timing of switching of the preceding vehicle by displaying with the sequence switched for both the display of preceding vehicle detection information for the prior vehicle 42 and the display of preceding vehicle detection information for the vehicle 45 that just entered. Also, even if made to perform only display of the preceding vehicle detection information for the vehicle 45 that just entered (while changing the display position to match the lane change of the vehicle 45), it is possible to give clear notification of the preceding vehicle that is currently being detected.

In a case such as when the abovementioned other vehicle 45 suddenly enters the lane so as to cut in, it is also possible to have a warning display as shown in FIG. 3B.

Also, as shown in FIG. 4A, it is possible to perform display of the synthesized image 24 that uses the lane detection information for the required display information 21, and uses the lane (its boundary lines 43R, 43L) for the live-action image 23. As a result, it is possible to display the current traveling status (lane departure status) in an easy to understand manner (status display).

Also, in a case such as when the degree of the lane departure becomes greater than a preset threshold value, or when the lane departure is repeatedly frequently, etc., as shown in FIG. 4B, it is also possible to switch from a status display to a warning display. In this case, the host vehicle is crossing the boundary line 43L of the left side of the lane, so the warning display is the left side boundary line 43L. When the host vehicle has crossed the boundary line 43R of the right side of the lane, the warning display is the right side boundary line 43R. Specifically, it is also possible to perform display according to a change in importance level.

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts unless otherwise stated.

As used herein, the following directional terms “frame facing side”, “non-frame facing side”, “forward”, “rearward”, “front”, “rear”, “up”, “down”, “above”, “below”, “upward”, “downward”, “top”, “bottom”, “side”, “vertical”, “horizontal”, “perpendicular” and “transverse” as well as any other similar directional terms refer to those directions of a vehicle.

The term “attached” or “attaching”, as used herein, encompasses configurations in which an element is directly secured to another element by affixing the element directly to the other element; configurations in which the element is indirectly secured to the other element by affixing the element to the intermediate member(s) which in turn are affixed to the other element; and configurations in which one element is integral with another element, i.e. one element is essentially part of the other element. This definition also applies to words of similar meaning, for example, “joined”, “connected”, “coupled”, “mounted”, “bonded”, “fixed” and their derivatives. Finally, terms of degree such as “substantially”, “about” and “approximately” as used herein mean an amount of deviation of the modified term such that the end result is not significantly changed.

While only selected embodiments have been chosen to illustrate the present invention, it will be apparent to those skilled in the art from this disclosure that various changes and modifications can be made herein without departing from the scope of the invention as defined in the appended claims. For example, unless specifically stated otherwise, the size, shape, location or orientation of the various components can be changed as needed and/or desired so long as the changes do not substantially affect their intended function. The functions of one element can be performed by two, and vice versa unless specifically stated otherwise. The structures and functions of one embodiment can be adopted in another embodiment. It is not necessary for all advantages to be present in a particular embodiment at the same time. Every feature which is unique from the prior art, alone or in combination with other features, also should be considered a separate description of further inventions by the applicant, including the structural and/or functional concepts embodied by such feature(s). Thus, the foregoing descriptions of the embodiments according to the present invention are provided for illustration only, and not for the purpose of limiting the invention as defined by the appended claims and their equivalents.

What is claimed is:

1. A vehicle head-up display device comprising:
a display device configured to perform reflective display of driving support information on a windshield of a vehicle; and
a display control device configured to control the display device, and including a synthesized image generating unit configured to synthesize required display information and a live-action image taken by a camera to display a synthesized image of the required display information and the live-action image on an entirety or a part of a screen of the display device.

2. The vehicle head-up display device according to claim 1, wherein
the synthesized image generating unit is configured to acquire the live-action image from the camera when it is determined that there is required display information while traveling, to generate the synthesized image, and to perform interrupt display on the screen of the display device.

3. The vehicle head-up display device according to claim 1, wherein
the synthesized image generating unit is configured to change a display position of the synthesized image in the screen of the display device according to an importance level of the required display information.

4. The vehicle head-up display device according to claim 1, wherein
the synthesized image generating unit is configured to change a size of the synthesized image displayed in the screen of the display device according to an object included in the required display information.

5. The vehicle head-up display device according to claim 1, wherein
the synthesized image generating unit includes:
a detection processing circuit unit configured to process a vehicle speed signal and a detection signal from a sensor;
an image capture circuit unit configured to acquire the live-action image from the camera; and
an image synthesis processing circuit unit configured to synthesize signals from the detection processing circuit unit and the image capture circuit unit.

6. The vehicle head-up display device according to claim 1, wherein the synthesized image generating unit is configured to generate at least one of
the synthesized image including preceding vehicle detection information as the required display information and an image of a preceding vehicle as the live-action image, and
the synthesized image including lane detection information as the required display information and an image of a lane as the live-action image.
